(19) United States
(12) Patent Application Publication
(10) Pub. No.: US 2024/0331025 A1
(43) Pub. Date: Oct. 3, 2024

(54) DYNAMIC BIDDING IN VIRTUAL COLLABORATIVE DOMAIN

(71) Applicant: International Business Machines Corporation, Armonk, NY (US)

(72) Inventors: Tushar Agrawal, West Fargo, ND (US); Atul Mene, Morrisville, NC (US); Jeremy R. Fox, Georgetown, TX (US); Sarbajit K. Rakshit, Kolkata (IN)

(21) Appl. No.: 18/190,808

(22) Filed: Mar. 27, 2023

(51) Int. Cl. G06Q 30/08; H04L 65/403

(52) U.S. Cl. CPC G06Q 30/08; H04L 65/403

(57) ABSTRACT

Techniques are described with respect to a system, method, and computer product for bidding on a virtual space. An associated method includes analyzing a first virtual collaborative domain and in response to the analysis, assigning a potentiality score of the virtual space for bidding of the first virtual collaborative domain. The method further including assigning a potentiality score of the virtual space for bidding of the first virtual collaborative domain; conducting a virtual auction for the virtual space; and in response to finalizing the virtual auction, infusing a second virtual collaborative domain with the first virtual collaborative domain.

### BACKGROUND

This disclosure relates generally to computing systems and augmented reality, and more particularly to computing systems, computer-implemented methods, and computer program products configured to support dynamic bidding in virtual collaborative domains.

Actions of users operating within collaborative environments, such as augmented reality-based virtual environments have become a valuable indictor of not only user analytics, but also prospecting venues for virtual content placement. For example, eSports and other applicable augmented reality-based concepts support gathering of users in virtual venues (e.g., arenas, stadiums, etc.) hosted over the internet which allow a larger audience than those of traditional professional sporting events. These virtual venues may include AR technology that provides placement of superimposed virtual content within virtual spaces of the virtual venues that are likely to be viewed by users in a manner in which the content displayed in the virtual spaces engages members in the audience.

### SUMMARY

Additional aspects and/or advantages will be set forth in part in the description which follows and, in part, will be apparent from the description, or may be learned by practice of the invention.

Embodiments relate to a method, system, and computer readable medium for bidding on a virtual space. In some embodiments, the computer-implemented method for bidding on a virtual space comprises analyzing a first virtual collaborative domain and in response to the analysis, assigning a potentiality score of the virtual space for bidding of the first virtual collaborative domain; assigning a potentiality score of the virtual space for bidding of the first virtual collaborative domain; conducting a virtual auction for the virtual space; and in response to finalizing the virtual auction, infusing a second virtual collaborative domain with the first virtual collaborative domain.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a virtual bidding system environment, according to an exemplary embodiment;

FIG. 3 illustrates a block diagram showing a bidding module and a collaborative environment module of the virtual bidding system of FIG. 1, according to an exemplary embodiment;

FIG. 4 illustrates a schematic diagram showing a virtual environment depicting a virtual arena including virtual spaces, according to an exemplary embodiment;

FIG. 5 illustrates a schematic diagram showing virtual content applied to a virtual space of the virtual arena of FIG. 4, as viewed through a computer-mediated reality device, according to an exemplary embodiment; and

FIG. 6 illustrates a flowchart depicting a method for bidding on a virtual space, according to an exemplary embodiment

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for bidding on a virtual space. Virtual reality (“VR”), augmented reality (“AR”), and/or mixed reality is becoming one of the most popular forms of presenting virtual content to users, consumers, etc. Various AR technologies support placement of superimposed virtual objects and content in components of the virtual environment in order for computer-mediated reality devices to locate and interact with AR resources. The virtual spaces where the virtual objects/content are superimposed and may be positioned within the virtual environment are subject to various factors including, but not limited to, the design of the virtual environment by the creator. However, these virtual spaces have become a target area ripe with opportunities for advertisers and multi-media content providers to grasp the attention of AR users while engaging with various virtual environments (e.g., E-sports events, virtual concerts, etc.). The present invention allows for virtual/digital spaces within virtual environments to be analyzed based on a plurality of factors including, but not limited to, the type of venue the virtual environment is (e.g., auditorium, virtual conference room, sports arena, etc.), the popularity of the virtual environment (i.e., the amount of users frequenting) based on historical usage, duration of stay of users (i.e., time spent in a virtual environment), and the like. These analyses of the virtual spaces allow for a potentiality score to be assigned which is utilized during a virtual space auction. The present invention further provides a virtual space bidding process of an auction in which a virtual appraisal is performed on the virtual space and the virtual space is auctioned off to the winning bidder. Upon finalizing the auction, a second virtual collaborative domain of the virtual environment is infused with a first virtual collaborative domain of the virtual environment allowing the winning bidder to display virtual content within the virtual space in a manner in which users of both virtual collaborative domains may view the virtual content. Thus, the present embodiments have the capacity to improve the analysis and allocation of virtual spaces within virtual environments along with optimize the presentation of virtual content within the virtual spaces in a manner in which users from different virtual collaborative domains are able to seamlessly view the virtual content within the virtual spaces.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described herein, virtual reality (“VR”) refers to a computing environment configured to support computer-generated objects and computer mediated reality incorporating visual, auditory, and other forms of sensory feedback. It should be noted that a VR environment may be provided by any applicable computing device(s) configured to support a VR, augmented reality, and/or mixed reality user interacting with their surroundings, said interactions including but not limited to user movement/gazing, manipulation of virtual and non-virtual objects, or any other applicable interactions between users and computing devices known to those of ordinary skill in the art.

As described herein, augmented reality is technology that enables enhancement of user perception of a real-world environment through superimposition of a digital overlay in a display interface providing a view of such environment. Augmented reality enables display of digital elements to highlight or otherwise annotate specific features of the physical world based upon data collection and analysis. For instance, augmented reality can provide respective visualizations of various layers of information relevant to displayed real-world scenes.

As described herein, a “virtual collaborative domain” is any applicable tool, resource, or digital space configured to be shared amongst a plurality of users, in which the physical locations of users are dispersed over a large geographical area; however, users are associated with computing devices operating within a shared virtual environment resulting in users being able to view the same virtual content simultaneously. Virtual collaborative domains may include but are not limited to distributed simulations, 3D multiplayer games, collaborative engineering software, collaborative learning applications, virtual arenas, conference rooms/multi-party discussion platforms, concerts, metaverses, or any other applicable shared resources known to those of ordinary skill in the art.

As described herein, a “virtual content” is any applicable type of multi-media (e.g., video, image, animation, music, and the like), avatar, virtual object (e.g., a sign, a label, a menu, a sticker, a brochure, a product packaging, a text, an audio, an infographics, a video, an animation, a hologram, etc.), electronic advertisement, offers, promotions, discounts, notification, etc. configured to be inserted into a digital and/or virtual space within a virtual environment.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

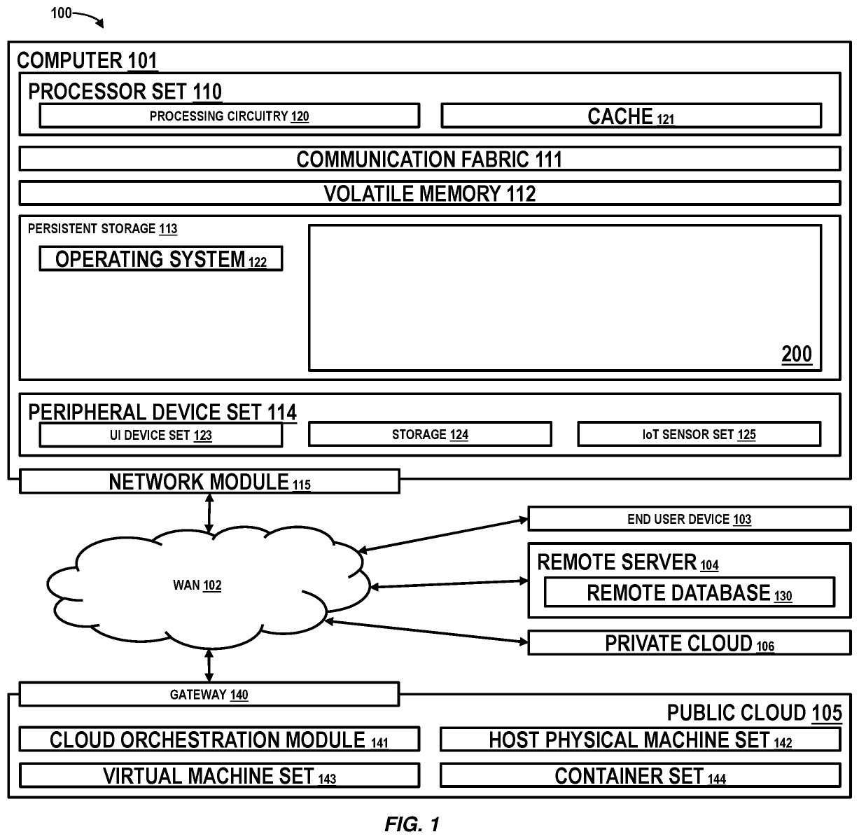

Referring now to FIG. 1, a computing environment 100 contains an example of an environment for the execution of at least some of the computer code involved in performing the inventive methods, such as virtual bidding system 200. In addition to virtual bidding system 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

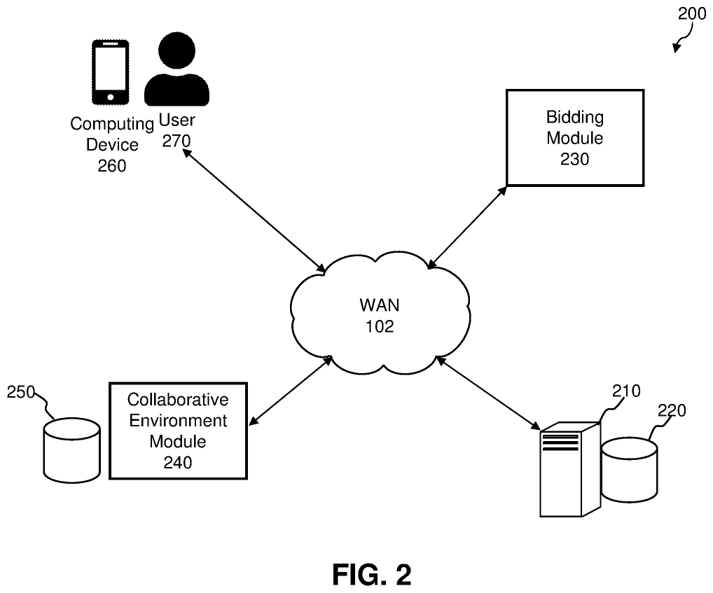

Referring now to FIG. 2, a functional block diagram of a networked computer environment illustrating a computing environment for a virtual bidding system 200 (hereinafter “system”) comprising a server 210 communicatively coupled to a database 220, a bidding module 230, a collaborative environment module 240 comprising a collaborative environment module database 250, a computing device 260 associated with a user 270, each of which are communicatively coupled over WAN 102 (hereinafter “network”) and data from the components of system 200 transmitted across the network is stored in database 220.

In some embodiments, server 210 is configured to operate a centralized platform serving as a cloud-based augmented reality virtual auction system designed for content providers, advertisers, and the like to access on the applicable computing devices which support user interfaces and application programming interfaces (APIs). In a preferred embodiment, the centralized platform is an augmented reality platform designed to allow a virtual space auction to occur in which not only are potentiality scores assigned to virtual spaces, but also virtual spaces within virtual environments are presented to the aforementioned parties allowing bids to be placed on virtual spaces and virtual appraisals to be performed on the virtual spaces. Upon finalizing of the virtual auction and a virtual appraisal if applicable, the applicable party that wins the auction is able to embed virtual content in the virtual space in a manner in which a second virtual collaborative domain (hereinafter referred to as “VCD”) is infused in a first VCD, each of which are maintained by collaborative environment module 240, allowing users within both VCDs to be presented the virtual content within the virtual space. In some embodiments, the VCD selected by user 270 is considered the first VCD, in which the configuration allows user 270 to function as the host of the first VCD and provide preferences as to the type of VCD that a second, third, etc. VCD must be. For example, the first VCD may be a virtual meeting and/or multi-party discussion and user 270 may specify that the second VCD integrated infused into the first VCD must be a virtual book stall/marketplace, food stall, ornament stall, etc. configured to be integrated and interacted with in the first VCD.

Bidding module 230 is tasked with operating the virtual auctions along with analyzing user analytics derived from computing device 260 and any other applicable sensor system known to those of ordinary skill in the art. In some embodiments, collaborative environment module 240 transmits analytics and metadata derived from previously and/or currently generated virtual environments and other VCDs to bidding module 230 over the network allowing bidding module 230 to analyze the analytics and metadata for purposes of generating a potentiality score of a digital/virtual space. It should be noted that one of the primary purposes of hosting the virtual auctions is to allows bids on digital/virtual space to be placed allowing virtual marketplaces, proprietors, and other applicable marketers (hereinafter referred to as “content providers”) who win the virtual space to showcase products, promotions, virtual support booths, advertisements, virtual objects, etc. within the virtual space. For example, a virtual marketplace may elect to participate in a virtual auction presented on the centralized platform in which the virtual marketplace posts respective bids for an available virtual space. The bids are configured to be stored in database 220 and viewed over the centralized platform, in which database 220 detects arrivals of new bids and bidding module 230 queries database 220 for the highest bid price offered for a particular virtual space; thus, contracts are formed with the highest bidder on the virtual space allowing them to apply their virtual content to the virtual space. In some embodiments, bidding module 230 communicates with server 210 to instruct server 210 to generate notifications provided over the centralized platforms that a virtual auction is about to begin, virtual space is available for receiving of biddings, or that a particular virtual space with a high potentiality score is about to be available for receiving bids.

Collaborative environment module 240 is configured to not only generate the virtual environments, but also to analyze virtual environments in order to ascertain virtual environment analytics and metadata which is taken into consideration when bidding module 230 facilitates the virtual auctions. For example, collaborative environment module 240 may ascertain the type of venue a virtual environment is (e.g., virtual conference, virtual sporting event, etc.), the number of users present in a virtual environment, the amount of traffic of a virtual environment (i.e., how often the venue is frequented), the average duration of stay of user 270 and/or users overall, and the like. This information is essential due to the fact that the aforementioned in taken into account by bidding module 230 when evaluating virtual spaces within virtual environments. For example, the value of a virtual space is higher if the virtual space is within a virtual environment that is frequented by users who are likely to interact with virtual content and/or historically has a large presence of users (e.g., virtual sporting event, virtual concert, etc.). Collaborative environment module 240 is further tasked with infusing VCDs allowing content within a first VCD to be infused with a second VCD resulting in not only the virtual content allocated to the virtual spaces to be viewed by users across multiple VCDs, but also supporting interactions with virtual content and users across VCDs. In some embodiments, the virtual auction and/or virtual appraisal is in response to the analysis performed on the first VCD which results in the virtual space for bidding being identified.

In some embodiments, collaborative environment module 240 is further configured to analyze user profiles in order to extract various data including, but not limited to, virtual environment activity of users, social media analytics (e.g., likes, posts, preferences, etc.), time spent within virtual environments, user field of view, and the like. The analyses of user profiles assist with the ascertaining of virtual environment analytics and metadata allowing bidding module 230 to optimize the application of potentiality scores assigned to virtual spaces. Furthermore, collaborative environment module 240 may define a plurality of rules specific for VCDs that may be utilized by bidding module 230 when bidding module 230 generates a plurality of predefined bidding rules associated with a virtual auction (e.g., timeframe for bids to be accepted, type of virtual content that may be assigned to virtual space, marketspace that may bid for the virtual space, etc.) configured to function as bidding criteria for the virtual auctions. Bidding criteria may be based on, but not limited to, one or more non-biddable digital space designations, a schedule for digital space bidding, a digital space bidder approved list, a digital space bidder unapproved list, a path of the predicted movement of the key focus area of virtual environments (based on historical learning), predicted viewing duration, the time of the display, the location of the virtual space, the size of the virtual space, a size of the audience in a portion of or entire virtual environment who can view the virtual content, a prediction of a context-based changing situation specific to the virtual environment (such as a player/team is about to score a goal vs. a player is just taking the ball), and an effectiveness of presenting virtual content for those specified constraints.

Computing device 260 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network or querying a database. In some embodiments, computing device 260 includes a plurality of sensors (e.g., accelerometers, position sensors, gyroscopes, etc.) configured to recognize activities of user 270 with virtual environments, VCDs, digital objects, other users, marketplaces, and the like.

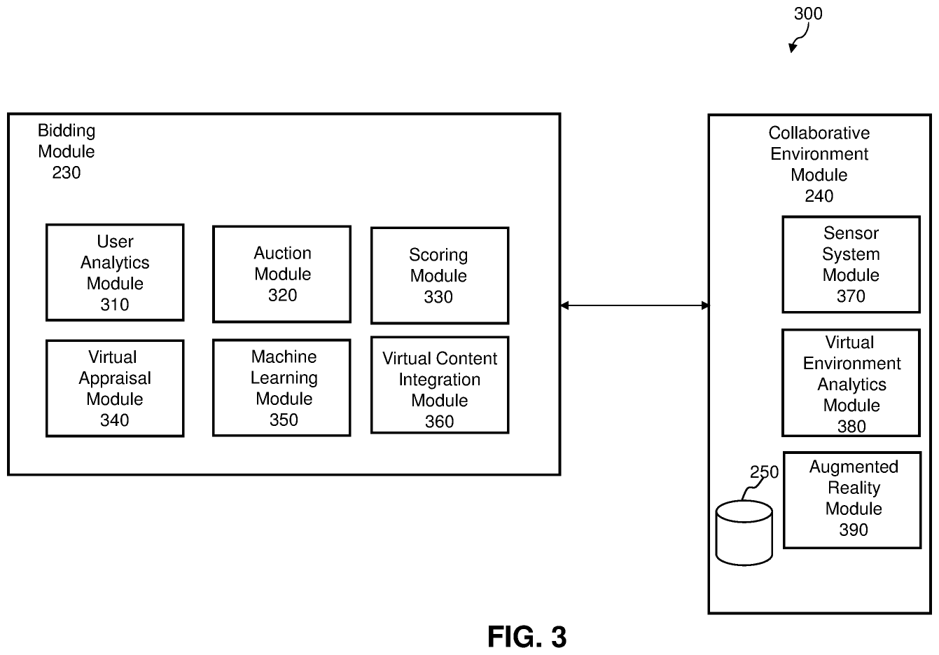

Referring now to FIG. 3, an example architecture 300 of bidding module 230 and collaborative environment module 240 is depicted, according to an exemplary embodiment. In some embodiments, bidding module 230 comprises a user analytics module 310, an auction module 320, a scoring module 330, a virtual appraisal module 340, a machine learning module 350, and a virtual content integration module 360. Collaborative environment module 240 comprises a sensor system module 370, a virtual environment analytics module 380, and an augmented reality module 390.

User analytics module 310 is configured to analyze various data associated with users within the virtual environments and VCDs in order to ascertain analytics and metadata associated with users within the virtual environments and VCDs. The various data may be acquired from server 210, computing device 260, and/or user profiles stored in collaborative environment module database 250, and may include but is not limited to activity data of users within the virtual environments and VCDs (e.g., gaze detection, virtual environment preferences, etc.), browsing patterns/activity derived from one or more crawlers associated with server 210, virtual content interacted with, user interests/hobbies, data derived from collaborative environment module 240, outputs of one or more machine learning modules operated by machine learning module 350, or any other applicable ascertainable user-specific data known to those of ordinary skill in the art. User analytics module 310 may further communicate with sensor system module 370 to identify selective mobility and activity behaviors of different users across VCDs, and update the user profiles with the resulting data.

Auction module 320 is configured to operate virtual auctions in which content providers bid on virtual spaces within virtual environments and the owners of the virtual spaces selects a bid based on the owner's preference. The bids could be money, rewards, or any other applicable type of consideration. In some embodiments, auction module 320 operates the virtual auction based on a plurality of defined rules, in which the rules may be selected automatically by auction module 320 and/or the applicable host/seller of the virtual space to serve as bidding criteria for the virtual auction. The rules may pertain to, but are not limited to, a period of time to place bids, the type of the virtual environment the virtual space is within (e.g., children-friendly venue, etc.), the amount of bids allowed, or any other applicable type of auction bid rule/regulation. Content providers may choose to preconfigure which factors and data they consider the most important and relevant to establish bidding criteria which will therefore have the most statistical weight during these computations. Also, virtual space owners may choose to preconfigure which factors and data they consider the most important and relevant to listing a virtual space (e.g., type of virtual content to be presented within the virtual space, marketspace of content provider, etc.), which will therefore have the most statistical weight during these computations. In some embodiments, a virtual auction may last for a predetermined amount of time and the virtual space owners may revise their offer price on the virtual space until the predetermined amount of time has expired. Auction module 320 may provide a blind auction that prevents an owner from seeing the offered asking prices of virtual spaces. As will be appreciated by those of skill in the art, many types of automated auction processes are known in the art and any such process may be utilized by auction module 320. Auction module 320 can be configured to automatically select and transfer ownership of the virtual space based on the offered prices within the bid and one or more quality metrics that may be optionally input in advance by the applicable party (i.e., the content provider). For example, the quality metrics may specify that the cheapest offer should be accepted or alternatively that the best value offer should be accepted.

Scoring module 330 is designed to allocate a potentiality score to a virtual space which is used by auction module 320 in the listing of a virtual space within the virtual auction. It should be noted that the potentiality score is based upon scoring module 330 taking into consideration a plurality of factors associated with the virtual space including, but not limited to, the type/context of the venue associated with the virtual environment, the location/placement position of the virtual space within the virtual environment, level of difficulty of integration of virtual content from first VCD to second VCD, and the like. In some embodiments, scoring module 330 utilizes the potentiality score assigned to virtual spaces as a means to rank virtual environments, VCDs, virtual spaces, and/or virtual content for the purpose of selecting virtual spaces to be listed in virtual auctions. For example, virtual spaces with a higher potentiality score have a higher probability of being not only highly valued, but also subject to more bids due to the fact that a virtual space with a high potentiality score is likely to result in more visibility and/or interaction with potential virtual content applied to the virtual space. Thus, scoring module 330 may rank a virtual space within a popular virtual venue higher than another virtual space within a less popular virtual venue based on the potentiality scores assigned to the virtual spaces respectively, in which historical usage of the virtual venue is used to ascertain the level of popularity of the virtual venue.

Virtual appraisal module 340 is tasked with performing assessments of virtual spaces within virtual environments and VCDs based on the aforementioned plurality of factors, assigned potentiality scores, virtual environment and VCD specific constraints, and the like. It should be noted that due to different requirements, bandwidths, configurations, etc. associated with operating and maintaining virtual environments and VCDs that it is necessary to account for the fact that a presentation of virtual content in the first VCD may alter from presentation of the same virtual content in the second VCD, or other relevant constraints. Thus, virtual appraisal module 340 is configured to not only handle assessment of virtual spaces for the purpose of portability of virtual content, but also assessing virtual environments and VCDs in order to determine potential virtual spaces within the second VCD for bidding. For example, in the instance in which the first VCD and the second VCD have different configurations, then virtual appraisal module 340 analyzes the second VCD in order to determine a potential digital/virtual space of the second VCD in which virtual content with a virtual space of the first VCD may be presented with the potential virtual space of the second VCD upon the infusion of the second VCD into the first VCD performed by augmented reality module 390.

Machine learning module 350 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are considered to be within the scope of this disclosure. In particular, machine learning module 350 is configured to operate and maintain one or more machine learning models configured to utilize training datasets derived from server 210, bidding module 230, and/or collaborative environment module 240 in order to ultimately generated outputs of the machine learning models representing predictions associated with virtual environments, VCDs, and/or users thereof. For example, the one or more machine learning models may generate predictions pertaining to the gaze direction of user 270, the duration of a virtual environment session associated with user 270, where within a virtual environment user 270 will be spending the most time, etc. For example, in the instance in which virtual appraisal module 340 detects multiple virtual spaces within a popular virtual venue (i.e., an E-sport arena), machine learning module 350 may predict that users will focus their attention to a virtual space within the center of the virtual venue where the action is taking place as opposed to in a corner of the virtual venue where visibility of the corner virtual space is more significantly limited. In some embodiments, over time machine learning module 350 may gather and store the outcomes of virtual auctions operated by auction module 320 and based on this data generate a prediction of a confidence level for which a given virtual space purchasing virtual content provider will purchase a virtual space at a given price in view of the current bids. For example, machine learning module 350 may predict there is a 50% chance that the virtual content provider will buy the virtual space at the current auction price, but if the seller lowers the price a 10% lower amount it will increase to a 55% chance, and if the seller lowers the price 20% it will increase to an 85% chance. Accordingly, in some embodiments, auction module 320 may be configured to provide suggestions or guidance to one or more sellers over the centralized platform in setting pricing for virtual spaces based on predictions generated by the one or more machine learning models operated by machine learning module 350.

Virtual content integration module 360 is tasked with integrating the virtual content of the highest bidder of the virtual auction into the virtual space upon finalization of the virtual appraisal and the virtual auction. In some embodiments, virtual content integration module 360 communicates with augmented reality module 390 in order to facilitate porting of the virtual content within the virtual space of the first VCD over to the virtual space of the second VCD during the infusion of the second VCD into the first VCD. As a result, the virtual content is seamlessly integrated into the second VCD in a manner in which users within the first VCD and the second VCD may simultaneously view and interact with the virtual content regardless of the respective virtual spaces due to the second VCD being infused into the first VCD.

Sensor system module 370 is a collection of one or more sensor systems designed to collect sensor data for the purpose of analyzing, mapping, and generating virtual environments. Furthermore, sensor system module 370 is configured to collect sensor data from computing device 260 associated with user 270 and their interactions with virtual environments and VCDs. The one or more sensor systems may include, but are not limited to cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IOT”) sensors, or any other applicable type of sensors known to those of ordinary skill in the art. For example, sensor system module 370 may receive sensor data from computing device 260 allowing sensor system module 370 to perform tracking of the gaze of user 270, in which the applicable sensor of computing device 260 captures images of the eyes of user 270 for analysis by sensor system module 370 which determines the gaze direction of user 270. The gaze determination is important within a virtual environment due to the fact it can be utilized to ascertain what user 270 is looking at/engaging within the virtual environment. It should be appreciated that the gaze direction of the user can be defined relative to computing device 260, relative to a real environment in which user 270 is situated, and/or relative to the virtual environment and/or VCD that is being rendered on computing device 260.

Virtual environment analytics module 380 is tasked with analyzing virtual environments and VCDs in order to ascertain analytics and metadata thereof. Analytics and metadata of virtual environments and VCDs may pertain to, but is not limited to, amount of users within a virtual venue, amount of time of users spent in virtual venue, user profiles of users across VCDs (e.g., preferences, etc.), types of activities users are performing within the virtual venue, selective interactive behaviors across VCDs, or any other applicable ascertainable virtual environment based data known to those of ordinary skill in the art. User profiles and/or profiles of virtual environments and VCDs may be stored in collaborative environment module database 250. Furthermore, virtual environment analytics module 380 classifies VCDs and captures selective collaboration information on VCDs allowing virtual appraisal module 340 to identify which digital spaces are available for bidding within the VCDs.

Augmented reality module 390 is tasked with not only generating AR-based virtual environments and VCDs (e.g., a virtual reality model of the scene/environment or superimposing virtual content over a real world view of the scene in augmented reality) based on data provided by server 210, bidding module 230, collaborative environment module 240, and/or sensor system module 370; but also, infusing and operating VCDs in a manner that allow interactions between users of multiple VCDs simultaneously. For example, the second VCD may be presented within the first VCD and respective virtual content and virtual objects may be shared among users seamlessly. Augmented reality module 390 may utilize various mechanisms and techniques known to those of ordinary skill in the art to present virtual content within the respective virtual spaces of the VCDs in a simultaneous manner. For example, the virtual content may comprise two-dimensional objects including AR markings configured to be triggered by interactions of user 270. For example, user 270 can swipe using onscreen touch gestures to move through the corresponding virtual content displayed on computing device 260; however, no AR markings (either two-dimensional or three-dimensional) are required. In some embodiments, the location of computing device 260 is determined to display the virtual content within the virtual space based on the location (e.g., gaze direction of user 270 within the virtual venue). In other embodiments, other technologies, such as a beacon technology, may be employed to deliver the virtual content to user 270 free of markings.

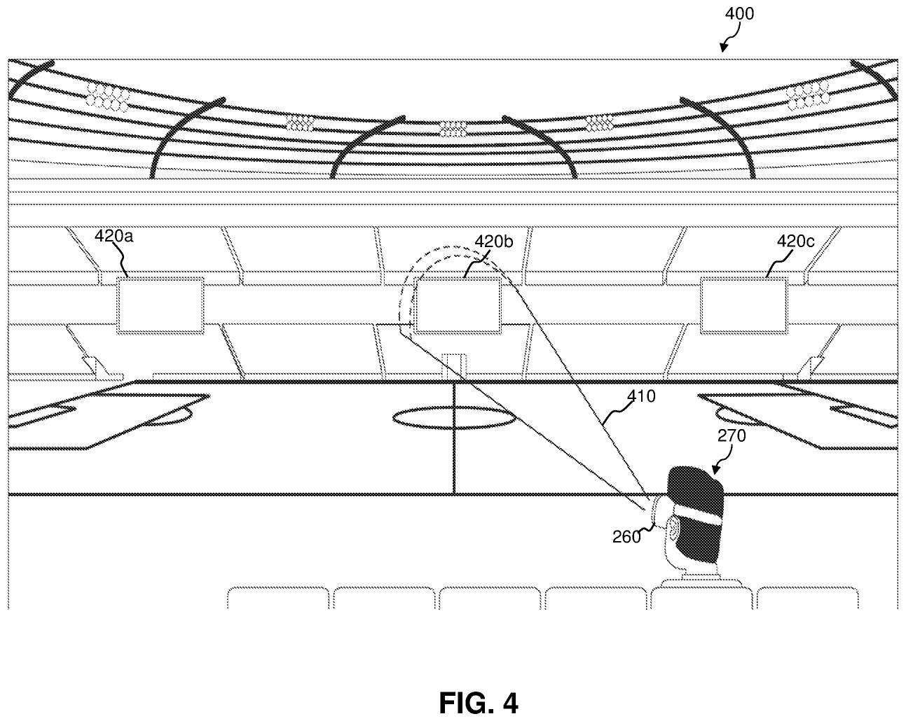

Referring now to FIG. 4, a first VCD 400 generated by augmented reality module 390 is depicted to user 270 donning computing device 260 is depicted, according to an exemplary embodiment. In some embodiments, first VCD 400 is an eSports arena showcasing a live eSports event, in accordance with one embodiment of the present disclosure. As shown in FIG. 4, user 270 is an audience member of the eSports event and a gaze direction 410 of user 270 within the virtual environment is detected via sensor system module 370. First VCD 400 is a VCD comprising virtual spaces 420a-c, each of which are configured to be listed for sale within a virtual auction operated by auction module 320. It should be noted that bidding for virtual spaces 420a-c is conducted in real-time, in which the virtual auction is configured to determine the price for virtual spaces 420a-c based on the virtual appraisal for each of virtual spaces 420a-c performed by virtual appraisal module 340. As previously mentioned, the virtual appraisal of virtual spaces 420a-c may be based upon a plurality of factors that include, but are not limited to, user population within first VCD 400, time in which applicable virtual content is to be displayed in virtual spaces 420a-c, visibility of virtual spaces 420a-c in relation to gaze direction 410, path of predicted movement of key focus areas within first VCD 400, a predicted duration of the visit of users within first VCD 400 generated by machine learning module 350, predicted gaze directions of users within first VCD 400 generated by machine learning module 350, a duration of visibility associated virtual spaces 420a-c, analysis of the user profile associated with user 270 performed by user analytics module 310, virtual environment behaviors of users within first VCD 400, or any other applicable data utilized for appraising virtual spaces known to those of ordinary skill in the art. Virtual appraisal module 340 with assistance from machine learning module 350 is further designed to provide techniques for the identification of locations and timing for displaying virtual content based on detected, tracked and/or predicted points of interest within first VCD 400, and techniques for determining or predicting effectiveness of virtual content with respect to a given point of interest.

In some embodiments, bidding module 230 is configured to detect whether user 270 is engaging with virtual spaces 420a-c based on gaze direction 410, in which the response to the determination is to initiate the virtual content at one or more of virtual spaces 420a-c; however, the initiation of the virtual content may occur based on the detected location computing device 260. For example, subsequent to finalizing the virtual auction, the presence of user 270 within first VCD 400 may initiate the presentation of the virtual content associated with the auction winner to user 270 at one or more of virtual spaces 420a-c or the detection of gaze direction 410 indicating user 270 is looking at virtual space 420b initiates virtual content being presented at virtual space 420b resulting in user 270 being able to view the virtual content via computing device 260. In another example, once the virtual content is triggered by user 270 interacting with one or more components of virtual spaces 420a-c, user 270 can swipe using AR-based gestures (i.e., swiping, etc.) to move through the corresponding virtual content displayed on the applicable AR interface of computing device 260. For example, after the brand logo of the content provider is displayed within virtual space 420b, user 270 may swipe left on the AR interface to be presented to the virtual content within virtual space 420b.

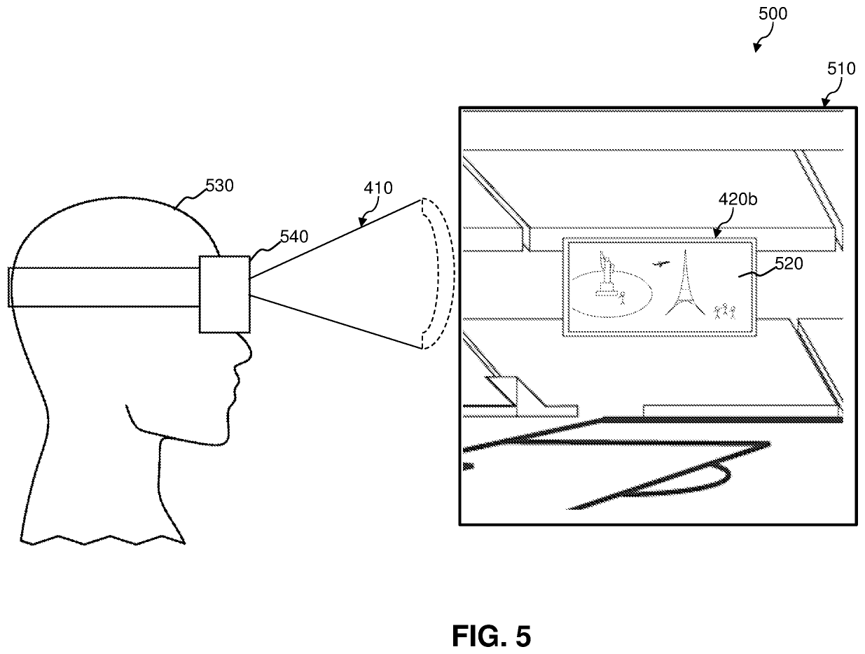

Referring now to FIG. 5, a second VCD 500 generated by augmented reality module 390 illustrating virtual space 420b including virtual content 520 of the first VCD depicted to a second VCD user 530 donning a computing device 540 is depicted, according to an exemplary embodiment. It should be noted that virtual content 520 is configured to viewed and interacted with by both user 270 of the first VCD and second VCD user 530 due to augmented reality module 390 infusing the VCDs. In some embodiments, second VCD 500 is infused into the first VCD based on augmented reality module 390 detecting the presence of second VCD 500, in which one or more elements of second VCD 500 (e.g., virtual content, virtual objects, virtual venue features, etc.) are infused into the first VCD based on the potentiality score(s) of virtual space 420b and/or any other applicable elements of the first VCD. Potentiality scores are configured be dynamically adapted and/or modified based on modifications/updates to the datasets utilized to initially generate the potentiality score resulting in a change in the offer price of virtual spaces, and also allowing different virtual content to be showcased within virtual spaces. For example, dynamic modifications to the virtual appraisal may be triggered by one or more changes to time, purpose, behaviors/activities of users within the virtual environment which may impact the potentiality scores. In addition, the infusion process performed by augmented reality module 390 supports bidding module 230 by allowing virtual auctions in a nested manner, wherein content providers can place bids on digital spaces in second VCD 500 via a third VCD allowing the third VCD to be able to showcase its respective virtual content. In some embodiments, the nested functionality is provided via augmented reality module 390 being able to maintain VCDs in a VCD library allowing each of the VCDs to be uniquely identified based on various factors such as, but not limited to, the classification of the VCD, amount of users in the VCD, and the like.

It should be noted that content providers/advertisers may elect to utilize three dimensional and/or two-dimensional objects to provide virtual content 520 to user 530, in which virtual content 520 may include, but is not limited to, labels, cards, signs, stickers, brochures, and the like. Furthermore, elements of virtual spaces used to trigger the virtual content may have graphics printed directly on said elements, or the elements may be blank and customized by the content provider by applying stickers or decals to create their own custom triggers. For example, a sticker allocated to virtual space 420b may state “Nod your head if you wish to save money on your car insurance”, in which the custom trigger of a nod performed by second VCD user 530 initiates the presentation of the virtual content associated with the applicable content provider. In some embodiments, virtual content 520 is context-based in which the content provider may modify virtual content 520 based on contextual data within the virtual environment at a given moment. For example, in the instance in which the eSport event is a soccer match, if a goal is about to be scored, then virtual content 520 will likely appear in many photographs taken by members of the audience, potentially leading to future viewing of virtual content 520. Thus, augmented reality module 390 is further designed to provide techniques for the identification of locations and timing for presenting virtual content based on detected, tracked and/or predicted points of interest, and techniques for determining or predicting virtual content effectiveness with respect to a given point of interest.

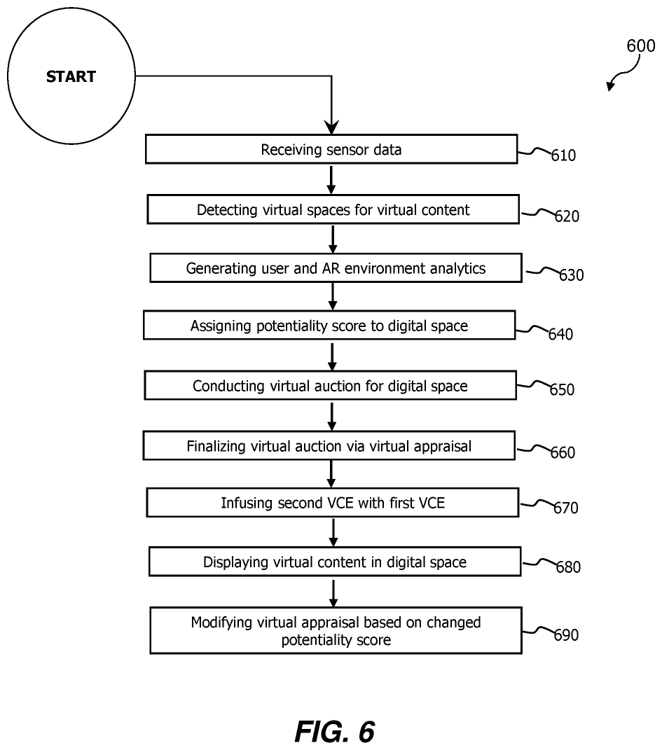

With the foregoing overview of the example architecture, it may be helpful now to consider a high-level discussion of an example process. FIG. 6 depicts a flowchart illustrating a computer-implemented process 600 for a method for bidding in a virtual space, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, sensor system module 370 receives a plurality of sensor data. Sensor data may include, but is not limited to, data feeds/video feeds, image data, audio data, thermal data, movement data, temperature, humidity, pressure, proximity, speed, rotation, light, gas, chemical levels, time-series data, or any other applicable data configured to be collected by sensors known to those of ordinary skill in the art. In some embodiments, computing device 260 and any other applicable computing device associated with collaborative environment module 240 collect the plurality of sensor data allowing augmented reality module 390 to generate virtual environments and VCDs by superimposing virtual objects within a virtual environment designed based on at least the plurality of sensor data.

At step 620 of process 600, virtual appraisal module 340 detects virtual spaces designed for virtual content. In some embodiments, virtual appraisal module 340 detects the virtual spaces based on collaborative environment module 240 performing analyses on virtual environments and VCDs in which the analyses may ascertain factors that may impact the evaluation of the virtual spaces performed by virtual appraisal module 340 including, but not limited to, the type/classification of a virtual environment (e.g., virtual classroom, virtual arena, virtual conference room, etc.), popularity of the virtual environment, and the like. The detection of virtual spaces may be triggered by one or more of a detected gaze of user 270, user 270 performing an AR-based gesture, design constraints of the virtual environment, selection made by virtual space owners on the centralized platform, etc.

At step 630 of process 600, user analytics module 310 generates user based analytics and virtual environment analytics module 380 generates virtual environment and VCD analytics. As previously mentioned, user based analytics may be derived from tracking user behavior within virtual environments and/or analyzing user profiles, and virtual environment and VCD analytics may include, but is not limited to, type/classification of venue of the virtual environment, the number of users present in a virtual environment the amount of traffic of a virtual environment (i.e., how often the venue is frequented), the average duration of stay of user 270 and/or users overall, predicted duration of stay, predicted gaze/area of focus within the virtual environment, and the like.

At step 640 of process 600, scoring module 330 calculates potentiality scores of the detected virtual spaces and assigns the potentiality scores to the virtual spaces. In some embodiments, the assigning of the potentiality scores may be performed simultaneously with the virtual appraisal; however, potentiality scores may be dynamically modified based on modifications/updates to the datasets utilized to initially generate the potentiality score resulting in a change in the offer price of virtual spaces, and also allowing different virtual content to be showcased within virtual spaces. For example, dynamic modifications to the virtual appraisal may be triggered by one or more changes to time, purpose, behaviors/activities of users within the virtual environment which may impact the potentiality scores.

At step 650 of process 600, auction module 320 conducts a virtual auction for a virtual space. In some embodiments, the virtual auction is conducted based on the plurality of predefined bidding rules associated with a virtual auction (e.g., timeframe for bids to be accepted, type of virtual content that may be assigned to virtual space, marketspace that may bid for the virtual space, etc.) configured to function as bidding criteria for the virtual auctions. Bidding criteria may be based on, but not limited to, one or more non-biddable digital space designations (e.g., space availability/unavailability), who may bid, amount of anticipated viewers of the virtual space, context of the virtual space, a schedule for digital space bidding, a digital space bidder approved listed, a digital space bidder unapproved list, and the like.

At step 660 of process 600, the virtual auction is finalized by the virtual appraisal performed by virtual appraisal module 340. In some embodiments, virtual appraisal module 340 with assistance from machine learning module 350 is further designed to provide techniques for the identification of locations and timing for displaying virtual content based on detected, tracked and/or predicted points of interest within the virtual environment and VCDs, and techniques for determining or predicting effectiveness of virtual content with respect to a given point of interest. The potentiality score may serve as an indicator of the range of pricing associated with the virtual space, allowing virtual space owners to ascertain a metric of what they should listing the virtual space for.

At step 670 of process 600, augmented reality module 390 infuses the second VCD with the first VCD. In some embodiments, the infusion of the VCDs not only supports interactions (e.g., communications, AR tools/mechanisms, AR designs, etc.) between the users of the respective VCDs, but also facilitates porting of the virtual elements within the virtual space of the second VCD over to the virtual space of the first VCD during the infusion of the second VCD into the first VCD. It should be noted that augmented reality module 390 supports nested infusion in which a plurality of VCDs may be infused allowing virtual elements and virtual content to be interacted with across VCDs in a seamless and simultaneous manner.

At step 680 of process 600, the virtual content is displayed within the virtual space by virtual content integration module 360. It should be noted that the virtual content is derived from the content provider that wins the virtual auction for the virtual space in which the virtual content may be infused into VCDs in a manner that allows users across VCDs to interact with virtual content regardless of the VCD it is derived from. It should be noted that augmented reality module 390 is configured to analyze virtual environments and identify appropriate virtual spaces for the virtual content to be overlayed, which may be unused and have sufficient space for the second VCD to displayed and interacted with.

At step 690 of process 600, the virtual appraisal for a virtual space is modified based on a change to the potentiality score. In some embodiments, a bid amount will be calculated dynamically for the virtual space depending upon one or more of a plurality of factors including, but not limited to, change of use for the virtual space, transfer of ownership of the virtual space, change of popularity of the virtual space, change of area of focus of a virtual space, contextual data associated with the virtual environment, increased demand for the virtual space, modified constraints associated with the virtual space (e.g., impacted bandwidth, unavailability, etc.), etc.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for bidding in a virtual space, the method comprising:
analyzing, by a computing device, a first virtual collaborative domain;
in response to the analysis, assigning, by the computing device, a potentiality score of the virtual space for bidding of the first virtual collaborative domain;
conducting, by the computing device, a virtual auction for the virtual space; and
in response to finalizing the virtual auction, infusing, by the computing device, a second virtual collaborative domain with the first virtual collaborative domain.

2. The computer-implemented method of claim 1, further comprising:
displaying, by the computing device, virtual content within the virtual space in both the first virtual collaborative domain and the second virtual collaborative domain; and
dynamically modifying, by the computing device, a virtual appraisal based on a change to the potentiality score.

3. The computer-implemented method of claim 1, wherein analyzing the first virtual collaborative domain comprises:
identifying, by the computing device, a popularity of the first virtual collaborative domain based on historical usage of a plurality of virtual collaborative domains and a plurality of user profiles of users operating within the plurality of virtual collaborative domains.

4. The computer-implemented method of claim 1, wherein assigning the potentiality score is based on one or more of a user population within the first virtual collaborative domain, a gaze direction of users operating within the first virtual collaborative domain, a predicted duration of virtual environment visit, a duration of visibility associated with the virtual space, and a user profile analysis.

5. The computer-implemented method of claim 1, wherein conducting the virtual auction comprises:
conducting, by the computing device, the virtual bidding process based on a plurality of predefined bidding rules; and
performing, by the computing device, a virtual appraisal for the virtual space.

6. The computer-implemented method of claim 5, wherein the plurality of predefined virtual bidding rules comprises one or more of non-biddable digital space designations, a schedule for digital space bidding, a digital space bidder approved list, and a digital space bidder unapproved list.

7. The computer-implemented method of claim 1, wherein users of the first virtual collaborative domain may interact with the second virtual collaborative domain and a plurality of elements of the second virtual collaborative domain.

8. A computer program product for bidding in a virtual space, the computer program product comprising one or more computer readable storage media and program instructions collectively stored on the one or more computer readable storage media, the stored program instructions comprising:
program instructions to; analyzing a first virtual collaborative domain;
program instructions to assign a potentiality score of the virtual space for bidding of the first virtual collaborative domain in response to the analysis;
program instructions to conduct a virtual auction for the virtual space; and
program instructions to infuse a second virtual collaborative domain with the first virtual collaborative domain in response to finalizing the virtual auction in response to finalizing the virtual auction.

9. The computer program product of claim 8, further comprising:
program instructions to display virtual content within the virtual space in both the first virtual collaborative domain and the second virtual collaborative domain; and
program instructions to dynamically modify a virtual appraisal based on a change to the potentiality score.

10. The computer program product of claim 8, wherein the program instructions to analyze the first virtual collaborative domain comprise:
program instructions to identify a popularity of the first virtual collaborative domain based on historical usage of a plurality of virtual collaborative domains and a plurality of user profiles of users operating within the plurality of virtual collaborative domains.

11. The computer program product of claim 8, wherein program instructions to assign the potentiality score is based on one or more of a user population within the first virtual collaborative domain, a gaze direction of users operating within the first virtual collaborative domain, a predicted duration of virtual environment visit, a duration of visibility associated with the virtual space, and a user profile analysis.

12. The computer program product of claim 9, wherein program instructions to conduct the virtual auction comprises:
program instructions to conduct the virtual bidding process based on a plurality of predefined bidding rules; and
program instructions to perform the virtual appraisal for the virtual space.

13. The computer program product of claim 12, wherein the plurality of predefined virtual bidding rules comprises one or more of non-biddable digital space designations, a schedule for digital space bidding, a digital space bidder approved list, and a digital space bidder unapproved list.

14. The computer program product of claim 8, wherein users of the first virtual collaborative domain may interact with the second virtual collaborative domain and a plurality of elements of the second virtual collaborative domain.

15. A computer system for bidding in a virtual space, the computer system comprising:
one or more processors;
one or more computer-readable memories;
program instructions stored on at least one of the one or more computer-readable memories for execution by at least one of the one or more processors, the program instructions comprising:
program instructions to analyzing a first virtual collaborative domain;
program instructions to assign a potentiality score of the virtual space for bidding of the first virtual collaborative domain in response to the analysis;
program instructions to conduct a virtual auction for the virtual space; and
program instructions to infuse a second virtual collaborative domain with the first virtual collaborative domain in response to finalizing the virtual auction in response to finalizing the virtual auction.

16. The computer system of claim 15, further comprising:
program instructions to display virtual content within the virtual space in both the first virtual collaborative domain and the second virtual collaborative domain; and
program instructions to dynamically modify a virtual appraisal based on a change to the potentiality score.

17. The computer system of claim 15, wherein the program instructions to analyze the first virtual collaborative domain comprise:
program instructions to identify a popularity of the first virtual collaborative domain based on historical usage of a plurality of virtual collaborative domains and a plurality of user profiles of users operating within the plurality of virtual collaborative domains.

18. The computer system of claim 15, wherein the program instructions to analyze the first virtual collaborative domain comprise:
program instructions to identify a popularity of the first virtual collaborative domain based on historical usage of a plurality of virtual collaborative domains and a plurality of user profiles of users operating within the plurality of virtual collaborative domains.

19. The computer system of claim 16, wherein program instructions to conduct the virtual auction comprises:
program instructions to conduct the virtual bidding process based on a plurality of predefined bidding rules; and
program instructions to perform the virtual appraisal for the virtual space.

20. The computer system of claim 19, wherein the plurality of predefined virtual bidding rules comprises one or more of non-biddable digital space designations, a schedule for digital space bidding, a digital space bidder approved list, and a digital space bidder unapproved list.
